(19) United States
(12) Patent Application Publication
(10) Pub. No.: US 2008/0235909 A1
(43) Pub. Date: Oct. 2, 2008

(54) Coupling

(76) Inventor: Annette Louise Miller, New South Wales (AU)

Correspondence Address: OSTROLENK FABER GERB & SOFFEN, 1180 AVENUE OF THE AMERICAS, NEW YORK, NY, 100368403, US

(21) Appl. No.: 11/996,100

(22) PCT Filed: Jul. 18, 2006
(86) PCT No.: PCT/AU2006/001012

§ 371 Date: Jun. 18, 2008

(30) Foreign Application Priority Data
Jul. 18, 2005 (AU) 2005203106

(51) Int. Cl. E05D 3/18; E05D 7/04; E05D 3/02

(52) U.S. Cl. 16/367

(57) ABSTRACT

Disclosed is a coupling, comprising a coupling arm, the coupling arm having an attachment portion adapted to be affixed with a first article, and an anchor portion. The coupling further comprises a receptacle adapted to be affixed with a second article, the receptacle comprising one or more walls defining an interior cavity, adapted to retain at least the anchor portion of the coupling arm. The receptacle further includes an opening adapted to allow the coupling arm to extend therethrough, wherein the attachment portion of the coupling arm is moveable with respect to the opening.

### FIELD OF THE DISCLOSURE

The disclosure relates to a coupling for walls, doors, containers or other building or construction elements.

### BACKGROUND TO THE DISCLOSURE

Traditional methods for hinging walls, doors, container lids and other construction or building materials are reliant on a dual base plate construction fitted together and connected by a single lynch pin fed through aligned apertures to form the coupling pivot point. The coupling is then affixed by each coupling base plate to independent surfaces (for example door and door mount) to both connect the two independent surfaces and allow one to move in relation to the other.

Many innovations have evolved in recent times in relation to coupling devices dependant on the application requirements, however the basic premise of the coupling's ability to allow two independent surfaces to be connected by the coupling and have a single point of articulation has not changed in the last one thousand years. Hinging devices have therefore always been an ancillary device to construction without the ability to provide substantial benefits to the structural integrity of something as large as a building. All traditional hinging methods are limited in both their application and ability to allow two surfaces to move in relation to each other, and if not fit for purpose cause major damage to their surrounding environment.

### SUMMARY OF THE DISCLOSURE

Disclosed is a coupling, comprising a coupling arm, the coupling arm having an attachment portion adapted to be affixed with a first article, and an anchor portion. The coupling further comprises a receptacle adapted to be affixed with a second article, the receptacle comprising one or more walls defining an interior cavity, adapted to retain at least the anchor portion of the coupling arm. The receptacle further includes an opening adapted to allow the coupling arm to extend therethrough, wherein the attachment portion of the coupling arm is moveable with respect to the opening.

In one form the coupling arm comprises two or more coupling segments, the coupling segments being hingedly attached to one another.

In one form the attachment portion of the coupling arm is moveable with respect to the opening in a direction away from the receptacle.

In one form the attachment portion comprises a face plate.

The attachment portion and the receptacle portion can provide an inherent strength and impact resistance along with a high load bearing capacity owing to the fact that the receptacle is incorporated into the second article while the attachment portion of the coupling arm can extend for a substantial portion of the first article. In one form the coupling arm is a flat plate arm and can act as a support system for the two articles it connects.

In one form the coupling arm is moveable between a closed position, where a substantial portion of the coupling arm is retained within the receptacle, and an open position, where a substantial portion of the coupling arm extends beyond the opening of the receptacle.

In one form the interior cavity is adapted to retain a substantial portion of the coupling arm either in aligned configuration or in a folded configuration when the coupling arm is in a closed position.

In one form the coupling segments are attached by means of one or more lynch pins.

In one form the coupling receptacle is adapted to be substantially incorporated within the second article.

In one form the coupling arm is hingedly attached with the first article.

In one form the anchor portion is adapted to be affixed within the receptacle.

In another form the anchor portion is adapted to be moveably retained within the receptacle.

In one form the coupling segments comprise substantially flat panels.

### BRIEF DESCRIPTION OF THE DRAWINGS

Embodiments of the coupling will now be described, by way of example only, with reference to the accompanying drawings in which:

FIG. 1 shows the a cross-sectional view of a coupling of one embodiment of the coupling in a closed position;

FIG. 2 shows a cross-sectional view of the coupling of FIG. 1 in an open position;

FIG. 3 shows a cross-sectional view of a coupling of a second embodiment of the coupling in a closed position;

FIG. 4 shows a cross-sectional view of a coupling of a third embodiment of the coupling in a closed position;

FIG. 5 shows a front elevation view of the coupling of FIG. 1 in use in a closed position;

FIG. 6 shows a front elevation view of the coupling of FIG. 1 in use in a fully closed position;

FIG. 7 shows a front elevation view of a plurality of couplings of a fourth embodiment of the coupling in use in a closed position

FIG. 8 shows a front elevation view of the couplings of FIG. 7 in use in a fully closed position.

### DETAILED DESCRIPTION OF PREFERRED EMBODIMENTS

Referring to the figures, disclosed is a coupling 20 comprising an attachment means 1 which is affixed to an article 21. The attachment means 1 is a plate composed of resilient or non-resilient material or a combination of materials such as moulded, pressed, stamped or extruded metals, laminated metals or high-tensile plastics.

The coupling 20 includes a coupling arm 3 which is anchored to the attachment means 1 at anchor point 2. The coupling arm 3 is anchored to the attachment means 1 by a method dependent on the material(s) used to construct the attachment means 1 and forms part of the attachment means structure.

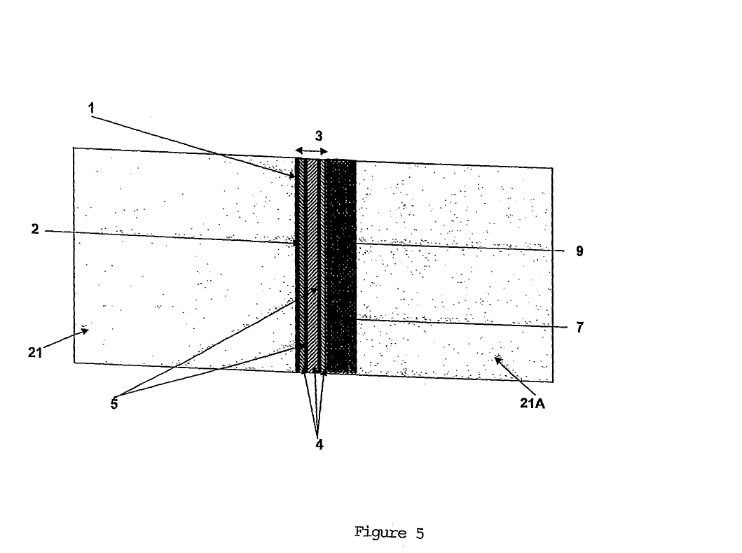

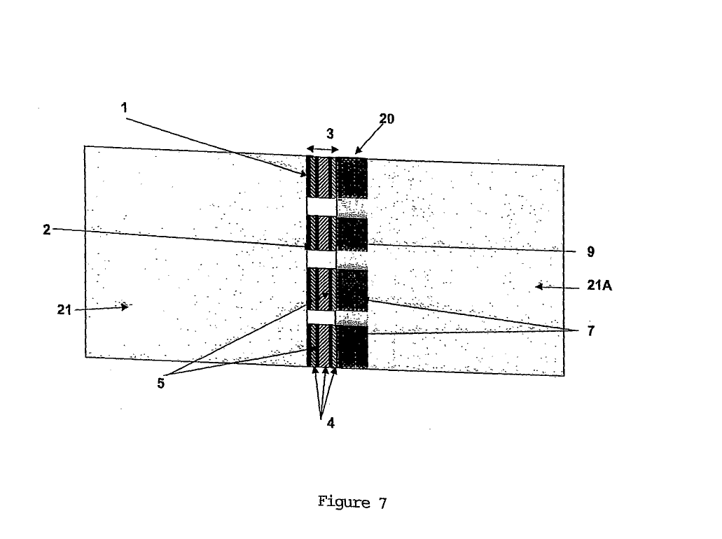

The coupling arm 3 comprises two coupling segments 4. The coupling segments 4 are composed of resilient or non-resilient material or a combination of materials such as moulded, pressed, stamped or extruded metals, laminated metals or hi-tensile plastics. The coupling segments 4 are interconnected by means of lynch pin inserts 5 or any other hinged connection method. Each coupling segment 4 comprises a substantially flat face as seen best in FIGS. 5 and 7. The overall dimension of each face plate coupling element 4 is dependant on the coupling application.

The coupling arm 3 is able to move in more than one direction because of the plurality of coupling segments 4 connected by lynch pins 5.

The coupling 1 further comprises a coupling retainer 7. The coupling retainer 7 comprises one or more walls 22 defining an interior cavity 23. The coupling arm 3 is anchored within the coupling retainer 7 by means of a free moving anchoring mechanism 9.

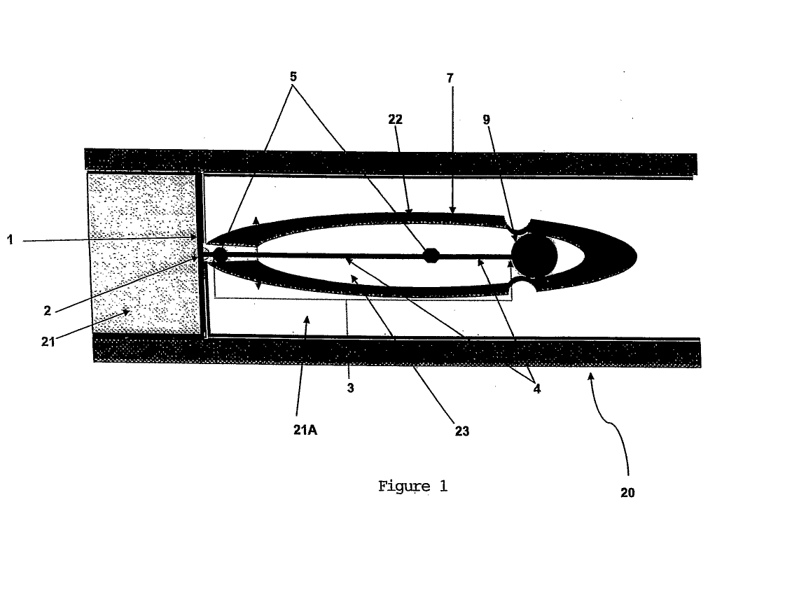

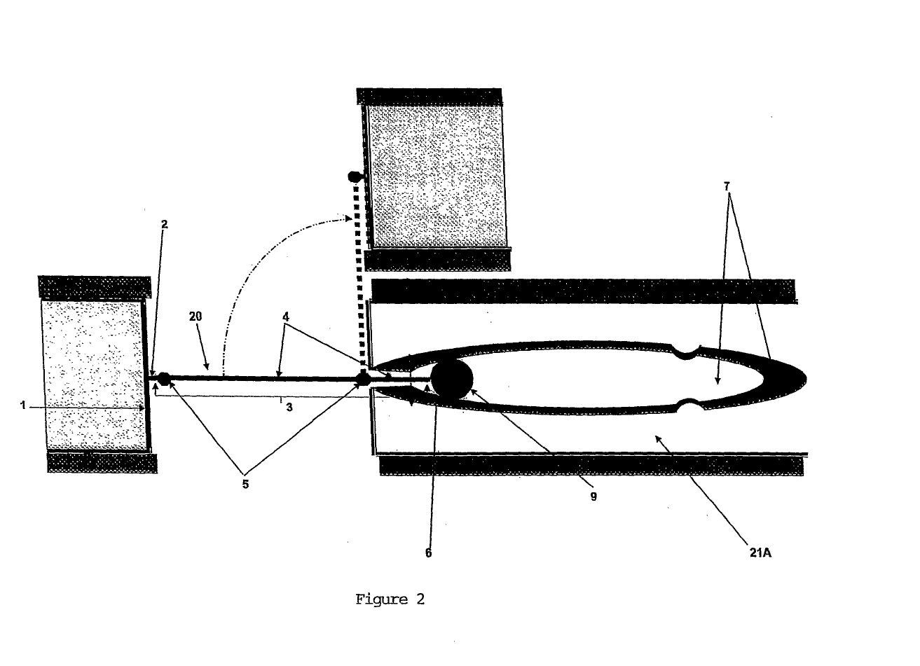

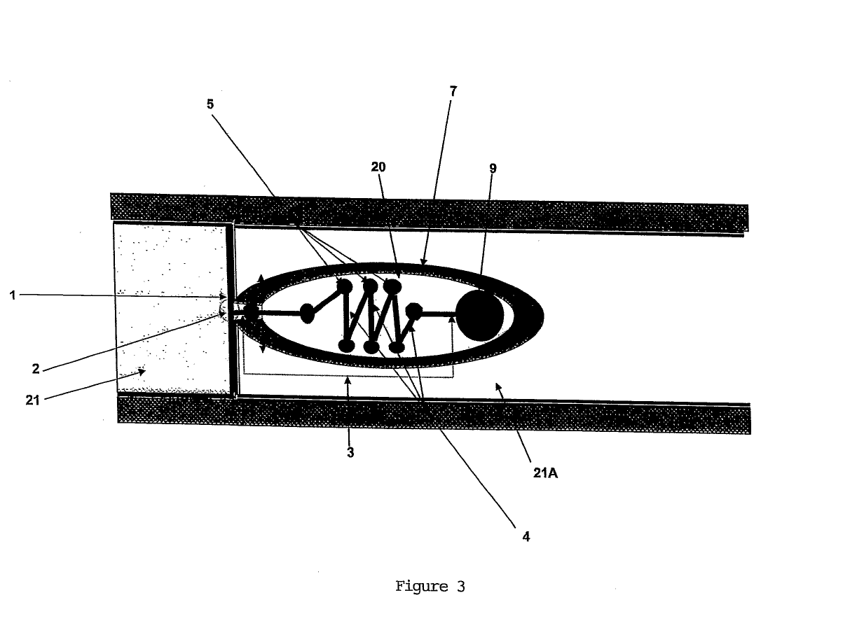

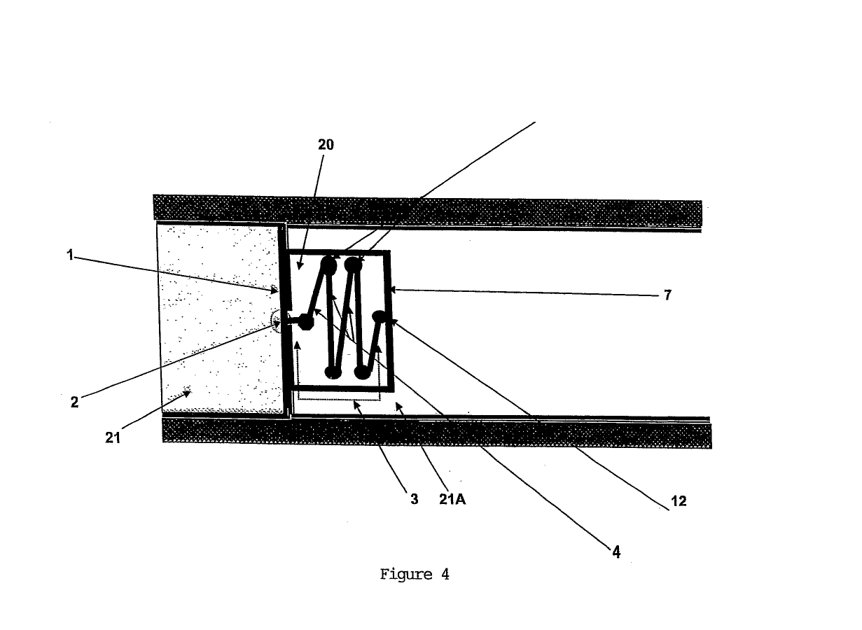

The free moving anchoring mechanism 9 can be locked into a closed position as best shown in FIGS. 1 and 2. In this position the coupling 1 is fully closed and locked by the shape of the coupling retainer 7. Alternately the free moving anchoring mechanism 9 can be free moving within the coupling retainer as best seen in FIG. 3, or permanently affixed to the back of the coupling retainer wall 22 as seen in FIG. 4. The coupling retainer 7 is composed of resilient or non-resilient material or combination of materials such as moulded, pressed, stamped or extruded metals, laminated metals or hi-tensile plastics. The coupling retainer 7 further includes a restricted opening 8 which is adapted to allow the coupling segments 4 to move into and out of the interior cavity of the coupling retainer 7.

It can be seen that when the attachment means 1 and the coupling retainer 7 are drawn together in the closed position as shown in FIGS. 1, 3 and 4, the coupling arm 3 is encapsulated within the coupling retainer 7.

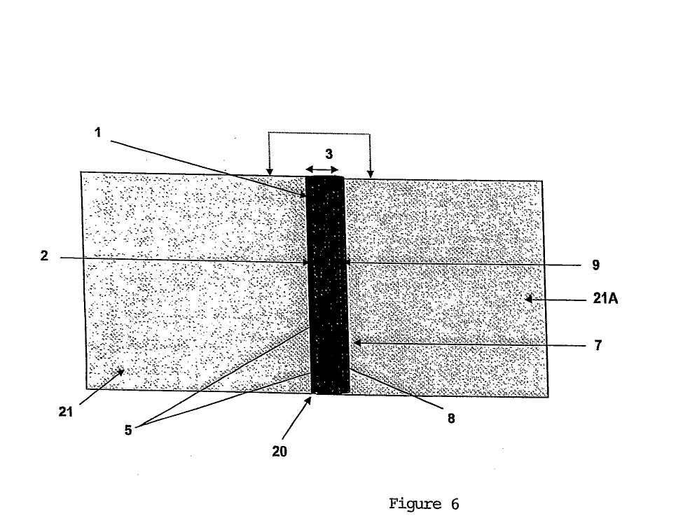

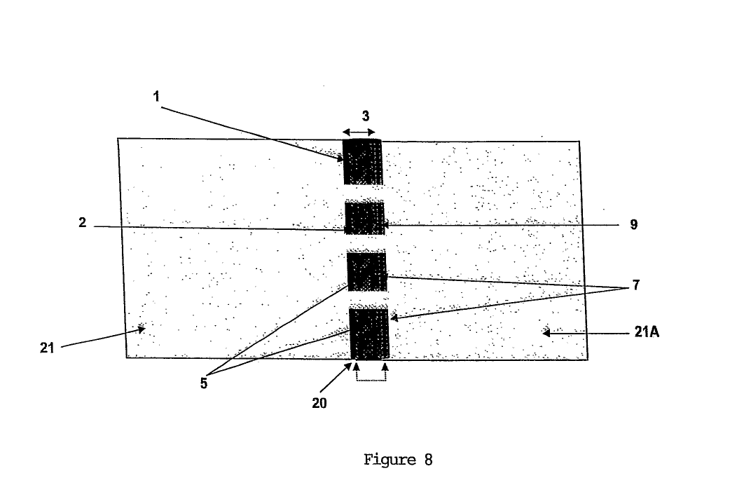

The coupling retainer 7 is adapted to be inserted into a second article 21A such that articles 21 and 21A are hingedly affixed together and moveable with respect to one another. The coupling retainer 7 is positioned within the confines of second article 21A so as articles 21 and 21A are adapted to come together in a seamless presentation when the coupling is fully closed as seen best in FIGS. 6 and 8. The coupling retainer 7 extends substantially along the length of the side of the second article 21A where it meets or is jointed with first article 21.

The attachment means 1 and coupling retainer 7 components can be incorporated into a preformed, moulded, or extruded formation, or created as part of the moulding or extruding process to seat the attachment means 1 and or coupling retainer 7 into a defined position within the formation 13 or created as a free form device.

In use, as best shown in FIG. 2, coupling arm 3 is extended through restricted opening 8 such that coupling segment 4 can be moved with respect to anchoring mechanism 9. As a result article 21 which is attached with coupling arm 3 by means of face plate 1 can be moved with respect to article 21A.

It can be seen that coupling 20 therefore allows articles 21 and 21A to be moved with respect to one another such that articles 21 and 21A can be seamlessly pressed against one another in a parallel manner as seen in FIGS. 6 and 8 and articles 21 and 21A can be moved into perpendicular relationship. In the closed position the attachment means 1 and coupling retainer 7 are drawn together allowing the coupling 20 to be fully concealed.

The coupling 20 is made of natural or man made materials or a combination of both and is either resilient or non-resilient. The material is capable of insertion and affixing to panel systems for building and the like.

In the preceding description and in the claims which follow, except where the context requires otherwise due to express language or necessary implication, the word “comprise” or variations thereof is used in an inclusive sense, i.e. to specify the presence of the stated features but not to preclude the presence or addition of further features in various embodiments.

Variations and modifications can be made in respect of the system described above and defined in the following statement of claim.

1. A coupling, comprising:
a coupling arm, the coupling arm having an attachment portion adapted to be affixed with a first article, and an anchor portion;
a receptacle adapted to be affixed with a second article, the receptacle comprising one or more walls defining an interior cavity, adapted to retain at least the anchor portion of the coupling arm and having an opening adapted to allow the coupling arm to extend therethrough,
wherein the attachment portion of the coupling arm is moveable with respect to the opening and the coupling arm comprises two or more coupling segments, the coupling segments being hingedly attached to one another and being moveable between a closed position, where a substantial portion of the coupling arm is retained within the receptacle, and an open position, where a substantial portion of the coupling arm extends beyond the opening of the receptacle.

2. A coupling as defined in claim 1, wherein the coupling segments are positioned in an extended formation when the coupling arm is in a closed position.

3. A coupling as defined in claim 2, wherein the coupling segments are attached by means of one or more lynch pins.

4. A coupling as defined in claim 1, wherein the coupling arm comprises a flat plate arm.

5. A coupling as defined in claim 1, wherein the attachment portion of the coupling arm is moveable with respect to the opening in a direction away from the receptacle.

6. A coupling comprising
a coupling arm, the coupling arm having an attachment portion adapted to be affixed with a first article, and an anchor portion;
a receptacle adapted to be affixed with a second article, the receptacle comprising one or more walls defining an interior cavity, adapted to retain at least the anchor portion of the coupling arm and having an opening adapted to allow the coupling arm to extend therethrough,
wherein the attachment portion of the coupling arm is moveable with respect to the opening and the coupling arm comprises a flat plate arm.

7. A coupling as defined in claim 6 wherein the coupling arm comprises coupling segments which are positioned in an extended formation when the coupling arm is in a closed position.

8. A coupling as defined in claim 6 wherein the coupling arm comprises coupling segments which are positioned in a stacked formation when the coupling arm is in a closed position.

9. A coupling as defined in claim 6 wherein the coupling arm comprises coupling segments which are positioned in a concertina formation when the coupling arm is in a closed position.

10. A coupling as defined in claim 6, wherein the anchor portion is adapted to be affixed within the receptacle.

11. A coupling as defined in claim 6, wherein the anchor portion is adapted to be moveably retained within the receptacle.

12. A coupling as defined in claim 6, wherein the coupling receptacle is adapted to be substantially incorporated into the second article.

13. A coupling as defined in claim 1, wherein the coupling arm is hingedly attached with the first article.

14. A coupling as defined in claim 1, wherein the anchor portion is adapted to be affixed within the receptacle.

15. A coupling as defined in claim 1, wherein the anchor portion is adapted to be moveably retained within the receptacle.

16. A coupling as defined in claim 1, wherein the coupling receptacle is adapted to be substantially incorporated into the second article.
